(19) United States
(12) Patent Application Publication
(10) Pub. No.: US 2019/0289769 A1
(43) Pub. Date: Sep. 26, 2019

(54) SYSTEMS AND METHODS FOR PERFORMING BALE COLLECTION OPERATIONS

(71) Applicant: CNH Industrial America LLC, New Holland, PA (US)

(72) Inventor: Ivan Antich, Willowbrook, IL (US)

(73) Assignee: CNH Industrial America LLC

(21) Appl. No.: 15/927,195

(22) Filed: Mar. 21, 2018

(51) Int. Cl. A01B 69/04; A01B 79/00; A01F 15/08; G05D 1/02

(52) U.S. Cl. CPC A01B 69/008; A01B 79/005; G05D 2201/0201; G05D 1/0274; G05D 1/0278; A01F 15/08

(57) ABSTRACT

A method for performing a bale collection operation may generally include accessing data associated with a plurality of baling paths traversed across a field during the performance of a baling operation, with each baling path being associated with at least one bale of a plurality of bales to be collected within the field. The method may also include determining a location of a staging area relative to the field for aggregating the bales and generating a plurality of guidance lines to be traversed when collecting the bales and delivering the bales to the staging area. In addition, the method may include guiding a work vehicle along the plurality of guidance lines to collect the bales within the field and deliver the bales to the staging area.

### FIELD OF THE INVENTION

The present subject matter relates generally to the collection of bales from a field following the performance of a baling operation and, more particularly, to systems and methods for performing a bale collection operation in a more effective and/or efficient manner.

### BACKGROUND OF THE INVENTION

In the field of agricultural operations, it is known to tow a baler behind a work vehicle (e.g., a tractor) when performing a baling operation. For example, following a prior harvesting operation, cutting operation, or windrowing operation, crop material is often deposited within a field in swaths or windrows. Thereafter, the baler may be towed across the field to collect the crop material and produce bales. For instance, the baler may collect the crop material via an intake or collection device located at the front of the baler and deliver such crop material to a baling chamber of the baler, within which the crop material is compacted into a bale of a predetermined shape (e.g., a round bale or a square/rectangular bale). The resulting bale is then ejected from the rear of the baler and deposited within the field.

Following the performance of a baling operation, the bales deposited within the field are collected. Typically, an operator manually drives a work vehicle to collect the various bales individually and transport each bale to a desired location. Unfortunately, given the baling process, bales are often scattered across the field randomly. As a result, the operator must rely on a visual assessment of the field to determine the order in which the bales should be collected and the path(s) that should be taken across the field when collecting each bale. Unfortunately, operators are often incapable of selecting the most efficient order and/or optimal paths for collecting the various bales scattered throughout the field, thereby resulting in increased collection times, increased fuel consumption, and/or greater operator fatigue. In addition, the performance of a bale collection operation often results in a significant amount of field compaction, particularly when the operator is simply relying on memory to determine which paths have already been taken across the field to collect bales.

Accordingly, systems and methods for collecting bales from a field that improve the efficiency of performing the associated bale collection operation and/or that reduce negative impacts to the field during the performance of the operation (e.g., compaction and/or yield losses) would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for performing a bale collection operation. The method may generally include accessing, with a computing device, data associated with a plurality of baling paths traversed across a field during the performance of a baling operation, with each baling path being associated with at least one bale of a plurality of bales to be collected within the field. The method may also include determining, with the computing device, a location of a staging area relative to the field for aggregating the bales and generating, with the computing device, a plurality of guidance lines to be traversed when collecting the bales and delivering the bales to the staging area. The guidance lines may include at least one bale collection guidance line defined relative to at least one of the baling paths and at least one staging guidance line extending between the bale collection guidance line(s) and the staging area. In addition, the method may include guiding, with the computing device, a work vehicle along the plurality of guidance lines to collect the bales within the field and deliver the bales to the staging area.

In another aspect, the present subject matter is directed to a system for performing a bale collection operation. The system may generally include a work vehicle configured to collect a plurality of bales located within a field and a controller provided in operative association with the work vehicle. The controller may include a processor and associated memory. The memory may store instructions that, when implemented by the processor, configure the controller to access data associated with a plurality of baling paths traversed across the field during the performance of a baling operation, with each baling path being associated with at least one bale of the plurality of bales. The controller may also be configured to determine a location of a staging area relative to the field for aggregating the bales and generate a plurality of guidance lines to be traversed by the work vehicle when collecting the bales and delivering the to the staging area. The guidance lines may include at least one bale collection guidance line defined relative to at least one of the baling paths and at least one staging guidance line extending between the bale collection guidance line(s) and the staging area. In addition, the controller may also be configured to guide the work vehicle along the guidance lines to collect the bales within the field and deliver the bales to the staging area.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of a work vehicle towing a baler in accordance with aspects of the present subject matter;

FIG. 2 illustrates a simplified view of a field within which a baling operation is being performed in accordance with aspects of the present subject matter, particularly illustrating the bales deposited within the field along baling paths traversed by the vehicle/baler;

FIG. 3 illustrates a schematic view of one embodiment of a system for performing a bale collection operation in accordance with aspects of the present subject matter;

FIG. 4 illustrates another view of the field shown in FIG. 2 following the performance of the baling operation, particularly illustrating a staging area superimposed over the field that represents that area at which the bales are to be aggregated during the bale collection operation;

FIG. 5 illustrates another view of the field shown in FIG. 4 following the performance of the baling operation, particularly illustrating guidance lines superimposed over the field for collecting the bales and transporting the bales back to the associated staging area; and

FIG. 6 illustrates a flow diagram of one embodiment of a method for performing a bale collection operation in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for performing bale collection operations (i.e., when collecting bales deposited within a field following a prior baling operation). In several embodiments, a controller of the system may be configured to generate a plan for optimizing the efficiency of the bale collection operation while taking into account any negative impacts to the field (e.g., compaction and/or yield losses). For example, the controller may be configured to generate guidance lines for collecting the various bales deposited within the field and for transporting such bales to a selected location defined relative to the field (e.g., a staging area) based, at least in part, on data associated with the previously performed baling operation (e.g., position data associated with the specific locations of the bales within the field and/or the specific locations of the baling paths traversed when performing the prior baling operation). The controller may then utilize the guidance lines for guiding a work vehicle across the field as each bale is collected and subsequently delivered to the selected staging area. For example, in one embodiment, the controller may be configured to automatically control the operation of the work vehicle such that the vehicle is moved across the field along the determined guidance lines without any operator input (e.g., for autonomous vehicle operation and/or when otherwise operating in an autonomous mode).

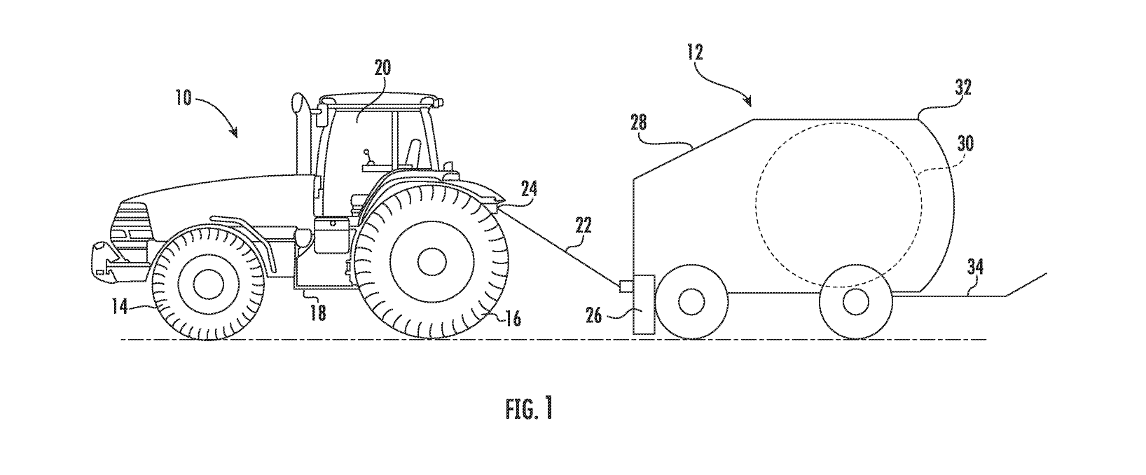

Referring now to the drawings, FIG. 1 illustrates a side view of one embodiment of a work vehicle 10 towing a baler 12 in accordance with aspects of the present subject matter to perform a baling operation within a field. As shown, the work vehicle 10 is configured as an agricultural tractor, such as an operator-driven tractor or an autonomous tractor. However, in other embodiments, the work vehicle 10 may correspond to any other suitable vehicle configured to tow a baler across a field or that is otherwise configured to facilitate the performance of a baling operation, including an autonomous baling vehicle. Additionally, as shown, the baler 12 is configured as a round baler configured to generate round bales. However, in other embodiments, the baler 12 may have any other suitable configuration, including being configured to generate square or rectangular bales.

As shown in FIG. 1, the work vehicle 10 includes a pair of front wheels 14, a pair or rear wheels 16 and a chassis 18 coupled to and supported by the wheels 14, 16. An operator's cab 20 may be supported by a portion of the chassis 18 and may house various input devices for permitting an operator to control the operation of the work vehicle 10 and/or the baler 12. Additionally, the work vehicle 10 may include an engine and a transmission (not shown) mounted on the chassis 18. The transmission may be operably coupled to the engine and may provide variably adjusted gear ratios for transferring engine power to the wheels 16 via a drive axle assembly.

As schematically shown in FIG. 1, the work vehicle 10 may be coupled to the baler 12 via a tongue 22 mounted on a hitch 24 of the work vehicle 10 to allow the vehicle 10 to tow the baler 12 across the field. As such, the work vehicle 10 may, for example, guide the baler 12 toward crop material deposited in windrows on the field. As is generally understood, to collect the crop material, the baler 12 includes a crop collector 26 (shown schematically in FIG. 1) mounted on the front end of the baler 12. The crop collector 26 may, for example, have a rotating wheel (not shown) that collects crop material from the ground and directs the crop material toward a bale chamber 28 of the baler 12. Inside the bale chamber 28, rollers, belts, and/or other devices compact the crop material to form a generally cylindrically shaped bale 30. The bale 30 is contained within the baler 12 until ejection of the bale 30 is instructed (e.g., by the operator). In other embodiments, the bale 30 may be automatically ejected from the baler 12 once the bale 30 is formed.

As shown in FIG. 1, the baler 12 may also include a tailgate 32 movable between a closed position (as shown in the illustrated embodiment) and an opened position via a suitable actuator assembly (not shown). In the closed position, the tailgate 32 may confine or retain the bale 30 within the baler 12. In the open position, the tailgate 32 may rotate out of the way to allow the bale 30 to be ejected from the bale chamber 28. Additionally, as shown in FIG. 1, the baler may include a ramp 34 extending from its aft end that is configured to receive and direct the bale 30 away from the baler 12 as it is being ejected from the bale chamber 28. In one embodiment, the ramp 34 may be spring loaded, such that the ramp 34 is urged into a raised position, as illustrated. In such an embodiment, the weight of the bale 30 on the ramp 34 may drive the ramp 34 to a lowered position in which the ramp 34 directs the bale 30 to the soil surface. Once the bale 30 is ejected, the bale 30 may roll down the ramp 34 and be deposited onto the field. As such, the ramp 34 may enable the bale 30 to maintain its shape and desired density by gently guiding the bale 30 onto the field.

It should be appreciated that the configuration of the work vehicle 10 described above and shown in FIG. 1 is provided only to place the present subject matter in an exemplary field of use. Thus, it should be appreciated that the present subject matter may be readily adaptable to any manner of work vehicle configuration. For example, in an alternative embodiment, a separate frame or chassis may be provided to which the engine, transmission, and drive axle assembly are coupled, a configuration common in smaller tractors. Still other configurations may use an articulated chassis to steer the work vehicle 10, or rely on tracks in lieu of the wheels 14, 16. Additionally, as indicated above, the work vehicle 10 may, in other embodiments, be configured as an autonomous vehicle. In such embodiments, the work vehicle 10 may include suitable components for providing autonomous vehicle operation and, depending on the vehicle configuration, need not include the operator's cab 20.

Additionally, it should be appreciated that the configuration of the baler 12 described above and shown in FIG. 1 is provided only to place the present subject matter in an exemplary field of use. Thus, it should be appreciated that the present subject matter may be readily adaptable to any manner of baler configuration. For example, as indicated above, the baler 12 may, in alternative embodiments, correspond to a square baler configured to generate square or rectangular bales.

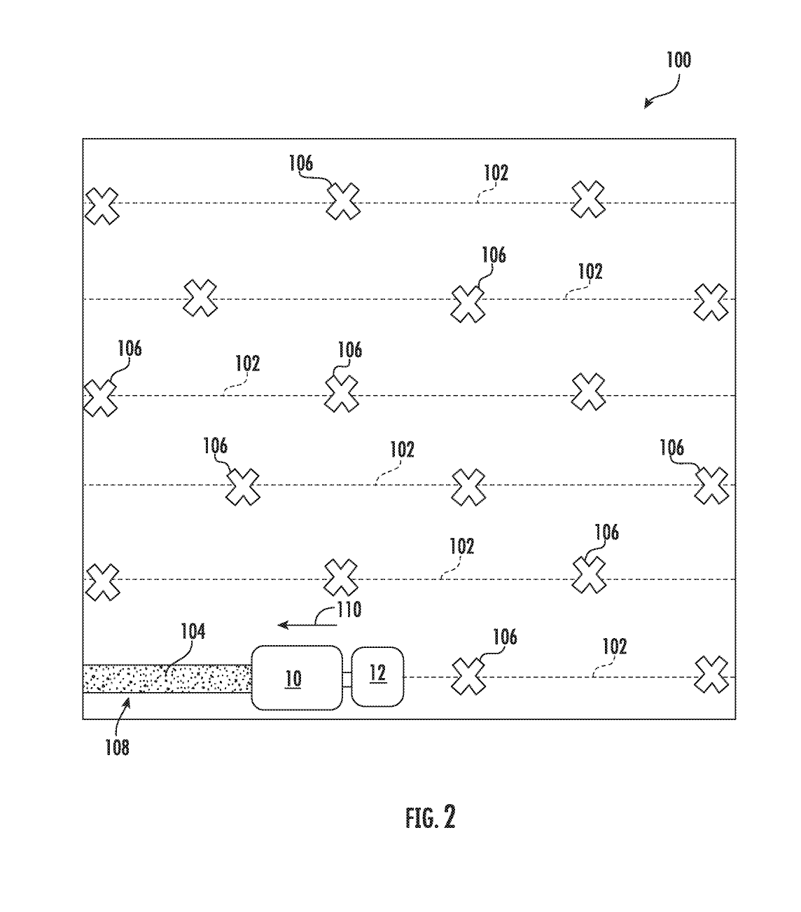

Referring now to FIG. 2, a simplified, top-down view of a field 100 in which a baling operation is being performed is illustrated in accordance with aspects of the present subject matter. In general, the baling operation will be described as being performed by the vehicle/baler 10, 12 described above with reference to FIG. 1. However, it should be appreciated that the baling operation may generally be performed using any suitable vehicle have any other suitable vehicle configuration and/or any other baler have any other suitable baler configuration.

As shown, the work vehicle 10 may be configured to tow the baler 12 across the field 100 along a plurality of baling paths (indicated by dashed lines 102 in FIG. 2) to collect crop material 104 from the field 100 and generate bales 106 (with each bale 106 deposited within the field 100 being indicated by an “X” in FIG. 2). In one embodiment, the baling paths 102 may be aligned with or defined relative to the location of crop material 104 previously deposited within the field 100 along a plurality of spaced apart windrows 108 (e.g., via a windrower). In such an embodiment, each baling path 102 may, for example, be substantially aligned with a centerline of a corresponding windrow 108. However, in other embodiments, the baling paths 102 may be defined across the field 100 in any other suitable manner that allows crop material 104 to be collected from the field 100 and subsequently baled. Additionally, it should be appreciated that, although the illustrated embodiment depicts straight or non-curved baling paths 102 extending across the field 100 in a given direction, the baling paths 102 may, instead, correspond to curved bailing paths and/or may extend across the field 100 in any other suitable direction.

As the tractor 10 tows the baler 12 across the field 100 along each baling path 102, the collected crop material 104 is baled within the baler 12 and subsequently ejected therefrom back into the field as a bale 106. As such, one or more bales 106 may be deposited along each baling path 102 as the tractor/baler 10, 12 make a given baling pass across the field 100. In this regard, it should be appreciated that the specific number of bales 106 deposited along each baling path 102 may generally vary based on, for example, the length of the baling path 102 across the field 100, the amount of crop material 104 to be collected along the baling path 102, and/or the desired size of each bale 106. Thus, although FIG. 2 shows three bales 106 deposited along each baling path 102, any other suitable number of bales 106 may be deposited along each baling path 102 during the performance of the baling operation, such as less than three bales 106 (e.g., two bales, one bale, or even zero bales) or greater than three bales 106 (e.g., four bales, five bales or more).

Additionally, in several embodiments, various types of data may be collected as the baling operation is being performed within the field 100. For example, in one embodiment, the work vehicle 10 and/or the baler 12 may be provided with a positioning device (e.g., a GPS device) that tracks the location of the tractor/baler 10, 12 as it is moved across the field 100. In such an embodiment, position data may be collected during the baling operation (e.g., by being recorded or stored within the memory of an on-board computer of the vehicle 10 and/or the baler 12) that is associated with the location/coordinates of each baling path 102 across the field 100 as well as the heading (e.g., as indicated by arrow 110 in FIG. 2) of the vehicle/baler 10, 12 with each baling pass made across the field 100. As is generally understood, the heading 110 of the vehicle/baler 10, 12 may differ between successive passes across the field 100. For example, the vehicle/baler 10, 12 may make a first pass across the field 100 along a given baling path 102 in a first direction (e.g., the direction of arrow 110 in FIG. 2). Thereafter, the vehicle/baler 10, 12 may turn around in the headlands and make a subsequent pass across the field 100 along another baling path 102 in the opposite direction.

In addition to collecting data associated with the position/coordinates of the baling paths 102 and the associated vehicle heading 110 along each baling path 102, data may also be collected/recorded that is associated with the specific position/coordinates of each bale 106 within the field 100. For instance, in one embodiment, for each bale 106 deposited within the field 100, a set of GPS coordinates may be recorded that corresponds to the exact location of such deposited bale 106 within the field 100. As a result, upon completion of the baling operation, a database of bale position data may be available that specifies the various positions of the bales 106 within the field 100. As will be described below, such bale position data may, for example, be utilized (e.g., alone or in combination with other position data) in planning and/or performing a subsequent bale collection operation to allow the various bales 106 to be collected and aggregated at a selected staging area.

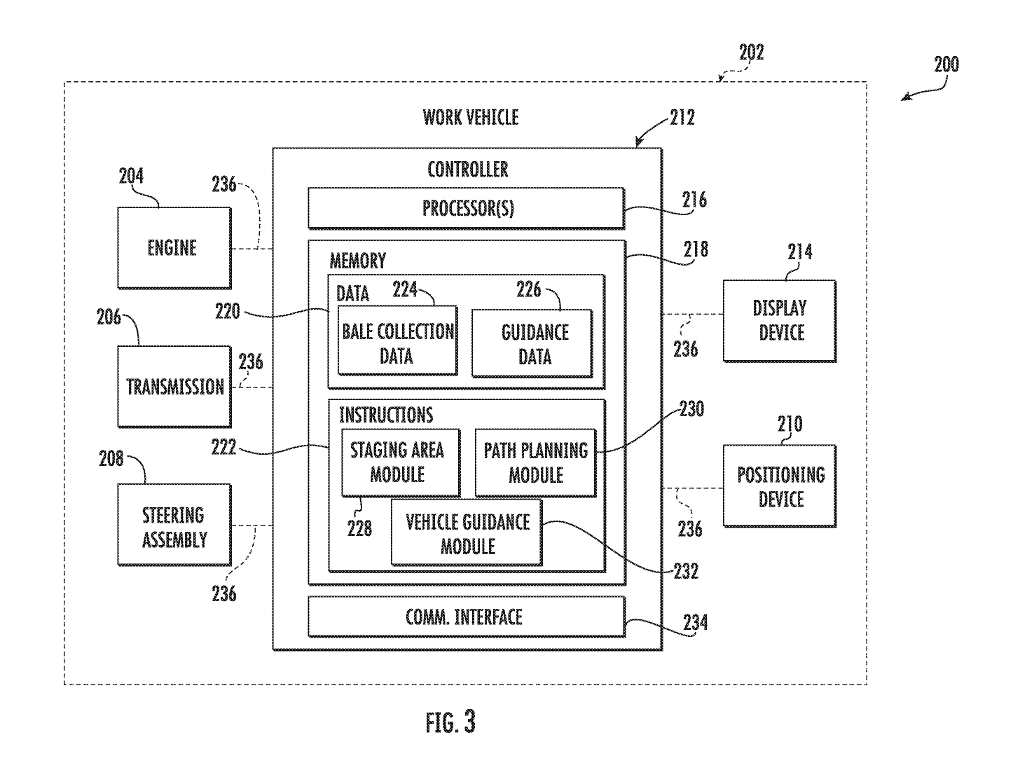

Referring now to FIG. 3, a schematic view of one embodiment of a system 200 for performing a bale collection operation is illustrated in accordance with aspects of the present subject matter. In general, the system 200 will be described herein with reference to the work vehicle 10 and the baler 12 described above with reference to FIG. 1. However, it should be appreciated that the disclosed system 200 may generally be utilized with work vehicles having any suitable vehicle configuration and/or balers have any suitable baler configuration. Additionally, for purposes of providing an illustrative example of a bale collection operation, the system 200 will generally be described herein with reference to performance of the bale collection operation following the example baling operation described above with reference to FIG. 2. However, it should be appreciated that the disclosed system 200 may generally be utilized to perform a bale collection operation following the performance of any suitable baling operation within any suitable field.

In several embodiments, the system 200 may include a work vehicle 202 configured to collect bales previously deposited within a field. In one embodiment, the work vehicle 202 may correspond to the vehicle 10 described above with reference to FIGS. 1 and 2. For example, upon completion of the baling operation, the baler 12 may be unhitched from the vehicle 10 and a suitable bale pick-up device or other implement (e.g., a bale spear) may be installed on the vehicle 10 to allow for the collection of bales from the field. In another embodiment, the work vehicle 202 may correspond to any other suitable vehicle that can be used to collect bales standing within the field, including any suitable autonomous vehicle and/or any suitable operator-driven vehicle (e.g., a skid-steer loader).

As shown in FIG. 3, the work vehicle 202 may include various components for allowing the vehicle 202 to be moved across the field during the bale collection operation. For example, the work vehicle 202 may include an engine 204 and a transmission 206 coupled to the engine 204 for propelling the vehicle 202 through the field. In addition, the work vehicle 202 may include a steering assembly 208 for steering the work vehicle 202. In one embodiment, the steering assembly 208 may be configured to be manually operated via the operator to steer the vehicle 202. Alternatively, the steering assembly 208 may be configured to be automatically controlled to allow the work vehicle 202 to be directed along a predetermined path(s) across the field. For example, in one embodiment, the steering assembly 208 may include or form part of an auto-guidance system for automatically steering the work vehicle 202. In such an embodiment, the work vehicle 202 may correspond to a fully autonomous vehicle, a semi-autonomy vehicle, or an otherwise manually operated vehicle having one or more autonomous functions (e.g., automated steering or auto-guidance functions).

Additionally, the work vehicle 202 may also include a positioning device 210 configured to monitor or track the position of the vehicle 202 as it is traversed across a field. For example, in one embodiment, the positioning device 210 may be configured to determine the exact location of the work vehicle 202 using a satellite navigation position system (e.g. a GPS system, a Galileo positioning system, the Global Navigation satellite system (GLONASS), the BeiDou Satellite Navigation and Positioning system, and/or the like).

As shown in FIG. 3, the system 200 may also include a controller 212. In one embodiment, the controller 212 may be communicatively coupled to one or more components of the work vehicle 202 (e.g., the engine 204, the transmission 206, and/or the steering assembly 208) for electronically controlling the operation of such component(s) (e.g. electronic control based on inputs received from the operator and/or automatic electronic control for executing one or more autonomous control functions). As will be described in greater detail below, the controller 212 may, in several embodiments, be configured to generate a plan for optimizing the efficiency of the bale collection operation while taking into account any negative impacts to the field (e.g., compaction and/or yield losses). For example, the controller 212 may be configured to generate guidance lines for collecting the various bales deposited within the field and for transporting such bales to a selected location defined relative to the field (e.g., a staging area) based, at least in part, on data associated with the previously performed baling operation (e.g., the position data associated with the specific locations of the bales within the field and/or the specific locations of the baling paths traversed when performing the prior baling operation). The controller 212 may then utilize the guidance lines for guiding the work vehicle 202 across the field as each bale is collected and subsequently delivered to the selected staging area. For example, in one embodiment, the controller 212 may be configured to automatically control the operation of the work vehicle 202 such that the vehicle 202 is moved across the field along the determined guidance lines without any operator input (e.g., for autonomous vehicle operation and/or when otherwise operating in an autonomous mode). Alternatively, the controller 212 may be configured to display the determined guidance lines on an associated display device 214 of the work vehicle 202 to allow the operator to navigate the vehicle 202 across the field based on the displayed guidance lines.

In general, the controller 212 may correspond to any suitable processor-based device(s), such as a computing device or any combination of computing devices. Thus, as shown in FIG. 3, the controller 212 may generally include one or more processor(s) 216 and associated memory devices 218 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 218 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 218 may generally be configured to store information accessible to the processor(s) 216, including data 220 that can be retrieved, manipulated, created and/or stored by the processor(s) 216 and instructions 222 that can be executed by the processor(s) 216.

In several embodiments, the data 220 may be stored in one or more databases. For example, the memory 218 may include a bale collection database 224 for storing data associated with the bales to be collected from the field during the performance of the bale collection operation. Such data may, for instance, include any data collected during the performance of the prior baling operation, such as the position data associated with the location of the baling paths relative to the field, the heading data associated with the heading of the vehicle/baler along each baling path, and/or the position data associated with the specific location of each bale within the field. In addition, various other types of data may be stored within the bale collection database 224. For example, in one embodiment, data may be stored within the bale collection database 224 that is associated with one or more operator inputs, one or more user-defined system preferences, and/or other system inputs relevant to one or more aspects of the present subject matter, such as data associated with the specific type of bales being collected (e.g., round bales vs. square/rectangular bales), data associated with the specific size of bales being collected (e.g., 4×5, 5×5, or 6×5), data associated with a desired or selected location for the staging area at which the bales will be aggregated, data associated with a desired spacing or arrangement of the collected bales within the staging area, and/or any other relevant data.

Additionally, as shown in FIG. 3, the memory 218 may also include a guidance database 226 for storing data associated with guiding the work vehicle 202 during the performance of the bale collection operation. For example, as indicated above, the controller 212 may be configured to generate guidance lines along which the work vehicle 202 is to be traversed when collecting the bales and subsequently aggregating the bales at the desired staging area. As such, the guidance database 226 may, for example, include data associated with the computer-generated guidance lines, such as GPS data or map data that maps each guidance line across the field.

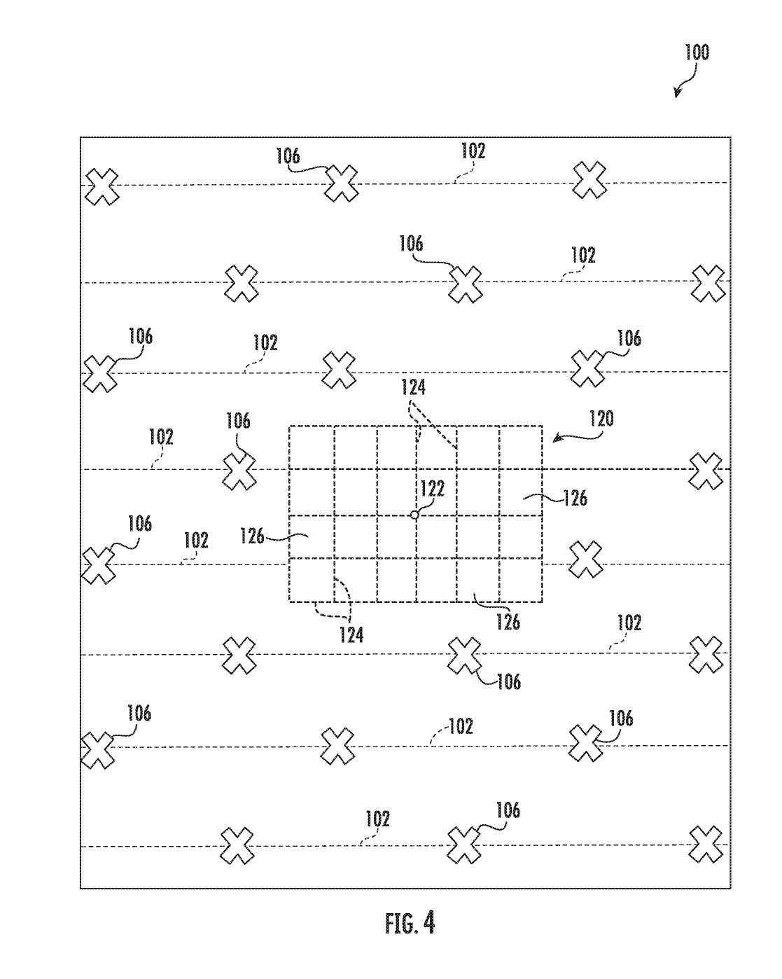

Referring still to FIG. 3, in several embodiments, the instructions 222 stored within the memory 218 of the controller 212 may be executed by the processor(s) 216 to implement a staging area module 228. In general, the staging area module 228 may be configured to determine a location(s) relative to the field that will serve as a “staging area” for aggregating the various bales being collected from the field. Specifically, in several embodiments, the staging area module 228 may be configured to automatically select the location for the staging area based on one or more factors, including, but not limited to, the locations of the various bales within the field, the size and/or shape of the field, and/or any user-defined or predetermined system preferences associated with the desired location of the staging area relative to the field. For example, as will be described below with reference to FIG. 4, in one embodiment, the staging area module 228 may be configured to automatically select a centralized location within the field to serve as the staging area. In such an embodiment, the centralized location may, for instance, be selected based on the geometric center of the field or based on the relative locations of the bales within the field. For example, by knowing the exact GPS coordinates of each bale within the field, a centralized location may be selected that minimizes the total distance to be traveled by the work vehicle 202 between the locations of the bales and the associated staging area.

In another embodiment, the staging area module 228 may be configured to determine the location of the staging area based on inputs received from an operator. For instance, the operator may be allowed to provide an input selecting the desired location of the staging area relative to the field. As an example, in one embodiment, a map of the field may be displayed to the operator via the display device 214 located within the operator's cab. In such an embodiment, the operator may provide an input(s) selecting a location on the map for the staging area.

It should be appreciated that the staging area at which the bales are to be aggregated may be located within the field, itself, or at a location outside the perimeter of the field. For instance, in certain embodiments, it may be desirable for the staging area to be located adjacent to a related bale storage facility (e.g., a barn or shed) positioned outside the field or at any other suitable non-field location selected to facilitate transport of the bales to another location.

In addition to determining the location of the staging area, the staging area module 228 of the controller 212 may also be configured to generate a staging grid within the staging area that defines the specific location at which each bale is to be placed within the staging area. For example, in one embodiment, the staging grid may correspond to an array of bale spaces or slots spaced apart across the staging area, with each bale slot specifying the location at which a given bale(s) should be placed within the staging area. In such an embodiment, the specific number of bale slots included within the staging grid, along with the size of each bale slot, may generally vary depending the type and/or size of the bales to be collected and/or any operator-selected preferences. For instance, when collecting round bales, the number of bale slots may be selected assuming a single bale will be placed within each bale slot, thereby creating a two-dimensional array of bales across the staging area (e.g., when the bales are not being stacked). However, when collecting square/rectangular bales, the number of bale slots may be selected, for example, to allow for two or more bales to be placed within each bale slot, thereby creating a three-dimensional array of bales across the staging area (e.g., when the bales are being stacked). Additionally, the size of each bale slot (e.g., the width/length of each slot) may vary depending on the corresponding size of each bale (e.g., the width/length of each bale) and/or a desired spacing parameter associated with the spacing between adjacent bales within the staging area. For example, an operator may be allowed to input a desired spacing distance to be defined between adjacent bales. In such an embodiment, the size of the bale slots may be selected to accommodate the desired bale spacing within the staging area.

As example view of a staging area that may be generated by the disclosed system controller 212 is illustrated in FIG. 4. Specifically, FIG. 4 illustrates a schematic view of the field 100 shown in FIG. 2 following the completion of the baling operation, particularly illustrating the bales 106 deposited within the field 100 along with the associated baling paths 102. Additionally, FIG. 4 illustrates a depiction of an example staging area 120 superimposed over a portion of the field that represents the area at which the various bales 106 are to be aggregated during the performance of the bale collection operation.

As shown in the illustrated example, the staging area 120 is generally defined at a centralized location within the field 100. For instance, in one embodiment, a center 122 of the staging area 120 may, in one embodiment, be located at or adjacent to the geometric center of the field 100. In another embodiment, the location of the center 122 of the staging area 120 may be selected based on the specific locations of the various bales 106 within the field 100, such as by locating the center 122 of the staging area 120 at a location within the field 100 that minimizes the total distance defined between the staging area 120 and the various bales 106. However, as indicated above, the staging area 120 may be located at any other suitable location within or outside the field 100, such as at any suitable operator-selected location.

Additionally, as shown in FIG. 4, a staging grid may be defined across the staging area 120 (e.g., as indicted by grid lines 124) that defines a plurality of bale spaces or slots 126 for placing the collected bales within the staging area 120. For example, in the illustrated embodiment, the staging grid 124 forms a six-by-four array of bale slots 126 to accommodate the various bales 106 deposited within the field 100. However, in other embodiments, the staging grid 124 may form any other suitable array of bale slots 126 for accommodating the bales 106. For example, as indicated above, the specific number of bale slots 106 included within the staging area 120 may generally vary based on the number of bales 106 to be collected, whether the bales 106 are to be stacked within the staging area 120, and/or any other relevant factors.

Referring back to FIG. 3, the instructions 222 stored within the memory 218 of the controller 212 may also be executed by the processor(s) 216 to implement a path planning module 230. In general, the path planning module 230 may be configured to generate guidance lines across which the work vehicle 202 is to be traversed when collecting the bales from the field and when subsequently delivering such bales to the associated staging area. In several embodiments, the locations of the various guidance lines may, in several embodiments, be selected by the path planning module 230 so as to maximize the efficiency of the bale collection operation (e.g., by selecting shortest paths) while taking into account and/or minimizing field compaction and/or yield losses. For example, in a particular embodiment, the guidance lines generated by the path planning module 230 may include both one or more bale collection guidance lines defined across the field relative to the various baling path(s) associated with the previous baling operation and one or more associated staging guidance lines connecting each bale collection guidance line to the staging area. In such an embodiment, the work vehicle 202 may be traversed along the staging guidance line(s) when moving from the staging area to a given bale collection guidance line to retrieve a given bale and when moving from the bale collection guidance line back to the staging area to deliver the collected bale thereto. In addition, the work vehicle 202 may be traversed across each bale collection guidance line to allow the vehicle 202 to access the specific location(s) of the bale(s) located along one or more of the baling paths extending adjacent to such bale collection guidance line.

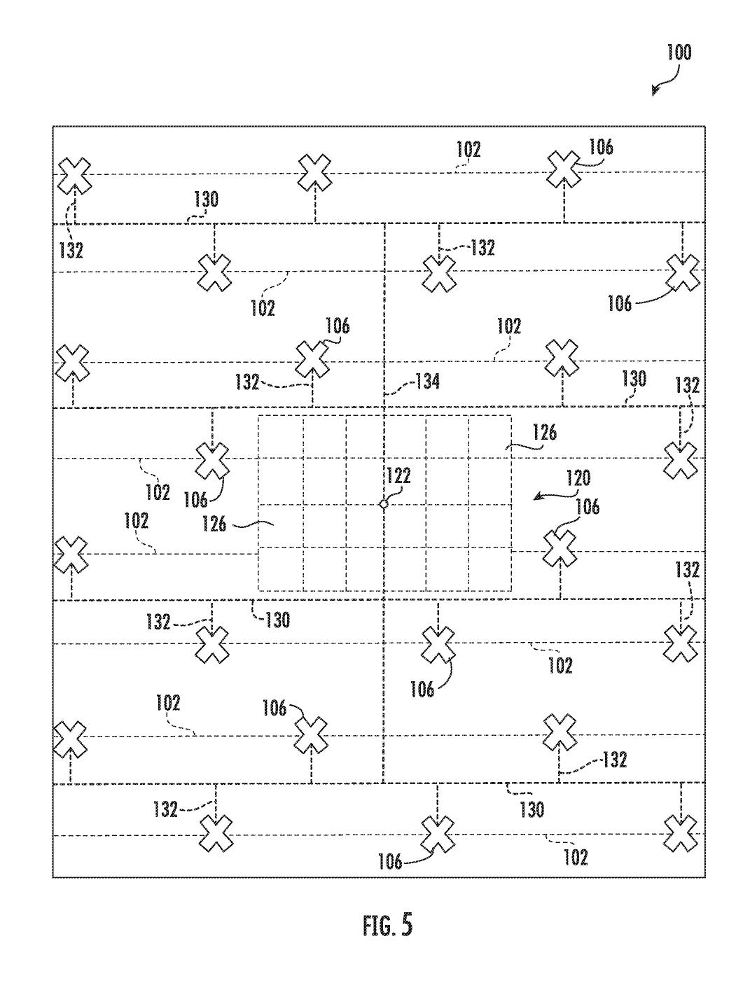

For instance, an example set of guidance lines that may be generated by the disclosed system controller 212 is illustrated in FIG. 5. Specifically, FIG. 5 illustrates a schematic view of the field 100 shown in FIG. 4 following the completion of the baling operation, particularly illustrating the bales 106 deposited within the field 100, the associated baling paths 102, and the example staging area 120 superimposed over a portion of the field 100. Additionally, FIG. 5 illustrates various guidance lines 130, 132, 134 superimposed over portions of the field 100 representing the paths across which the work vehicle 202 is to be traversed when collecting the bales 106 and subsequently delivering the collected bales 106 to the staging area 120.

As shown, a plurality of bale collection guidance lines 130 have been defined across the field 100 at offset locations from the various baling paths 102. Specifically, in several embodiments, each bale collection guidance line 130 may be defined at a location between a corresponding pair of adjacent baling paths 102, such as by centering each bale collection guidance line 139 between the corresponding pair of adjacent baling paths 102. For example, as shown in FIG. 5, each bale collection guidance line 130 extends across the field 100 generally parallel to and centered between an associated pair of baling paths 102. In such an embodiment, by traversing across a given bale collection guidance line 130, the work vehicle 202 may directly access the bales 106 associated with both of the adjacent baling paths 102, thereby minimizing field compaction and reducing yield losses via the utilization of a single bale collection guidance line 130 for collecting two rows or lines of bales 106. Additionally, in one embodiment, a short retrieval guidance line 132 may, when necessary, be defined between each bale collection guidance line 130 and the specific location of each bale 106 accessible via such bale collection guidance line 130 to allow the work vehicle 202 to retrieve the various bales 106. For instance, as shown in FIG. 5, each retrieval guidance line 132 may be extend perpendicularly from the associated bale collection guidance line 130 to the location of each corresponding bale 106.

It should be appreciated that, in other embodiments, the bale collection guidance lines 130 may be defined relative to the various baling paths 102 and/or relative to the various locations of the bales 106 in any other suitable manner that allows for the collection of the bales 106 by the work vehicle 202. For example, in another embodiment, each bale collection guidance line 130 may be aligned with one of the baling paths 102 such that the work vehicle 202 is traversed along the same path as the vehicle/baler 10/12 used to perform the prior baling operation.

Moreover, as shown in FIG. 5, a common staging guidance line 134 has been defined across the field 100 that connects each bale collection guidance line 130 to the staging area 120. As such, the work vehicle 202 may be traversed across a single path when exiting the staging area 120 to retrieve a bale 106 (e.g., via an associated bale collection guidance line 130) and when delivering the collected bale 106 back to the staging area 120, thereby reducing field compaction and yield losses. For example, as shown in the illustrated embodiment, the staging guidance line 134 is generally aligned with the center of the staging area 122 and extends across the field 100 generally perpendicularly to the bale collection guidance lines 130. However, in other embodiments, the staging guidance line134 may be defined at any other suitable location relative to the staging area 120 and/or may have any other suitable orientation relative to the bale collection guidance lines 130 that allows the staging guidance line 134 to form a common path connecting the various bale collection guidance lines 130 to the staging area 120.

It should be appreciated that, in other embodiments, two or more staging guidance lines 134 may be defined across the field 100. For instance, in one embodiment, a first staging guidance line may be defined across a portion of the field to allow the work vehicle 202 to access the bale collection guidance lines 130 defined along one side of the staging area 120 (e.g., the upper portion or the left portion of the field 100) and a second staging guidance line may be defined across another portion of the field 100 to allow the work vehicle 202 to access the bale collection guidance lines defined along the opposed side of the staging area 120 (e.g., the lower portion or the right portion of the field 100). In such an embodiment, the separate staging lines may, for example, be offset from one another in more directions and may each define any suitable orientation relative to their associated bale collection guidance lines 130.

It should also be appreciated that, although not shown, one or more separate slot guidance lines may also be defined within the staging area 120 for delivering each collected bale 106 to its corresponding bale slot 126 once the work vehicle has entered into the staging area 120 via the staging guidance line(s) 134. In such embodiments, each slot guidance line may, for example, extend from the staging guidance line(s) 134 and intersect one or more bale slots 126. For instance, it may be desirable for each slot guidance line to serve as a common slot guidance line for two or more bale slots 126 to minimize compaction and/or yield losses within the staging area 120.

Referring back to FIG. 3, in addition to defining the various guidance lines across the field, the path planning module 230 may also be configured to determine both the order in which the various bales should be collected by the work vehicle 202 and the specific bale slot in which each bale should be placed. For example, in one embodiment, the path planning module 230 may be configured to initially identify the specific bale slot in which each bale to be collected should be placed based on the relative positioning and/or distances between the various bales and the associated bale slots of the staging area. Specifically, in one embodiment, the bale slots may be matched to corresponding bales in a manner that minimizes the distance that must be traveled by the work vehicle 202 across the guidance lines between each bale and its associated bale slot. Once each bale has been assigned to a bale slot, the path planning module 230 may then identify the specific order in which the various bales should be collected to allow each bale to be delivered to its corresponding bale slot without having previously collected bales form barriers or obstacles within the staging area.

For instance, referring to the example shown in FIG. 5, the path planning module 230 may assign each bale 106 within the field 100 to a corresponding bale slot 126 based on the relative positioning of the bales 106 to the staging area 120. Specifically, referring to the view of the field shown in FIG. 5, the bales 106 located within the upper left portion of the field 100 may be assigned to the bale slots 126 located within the upper left portion of the staging area 120 while the bales 106 located within the upper right portion of the field 100 may be assigned to the bale slots 126 located within the upper right portion of the staging area 120. Similarly, referring again to the view of the field 100 shown in FIG. 5, the bales 106 located within the lower left portion of the field 100 may be assigned to the bale slots 126 located within the lower left portion of the staging area 120 while the bales 106 located within the lower right portion of the field 100 may be assigned to the bale slots 126 located within the lower right portion of the staging area 120. In such an embodiment, the order in which the various bales 106 are collected may, for example, be selected by the path planning module 230 to prevent any previously placed bales 106 from serving as potential obstacles, such as by placing the bales 106 assigned to the bale slots 126 located furthest from the staging guidance line(s) 134 first and then working back towards the staging guidance line(s) 134. For instance, in the embodiment shown in FIG. 5, it may be desirable to place the bales 106 assigned to the slots 126 located around in the corners of the staging area 120 and/or around the outer perimeter of the staging area 120 first and prior to placing bales 106 within any of the bale slots 126 located closer to the staging guidance line(s) 134.

Referring back to FIG. 3, the instructions 222 stored within the memory 218 of the controller 212 may also be executed by the processor(s) 216 to implement a vehicle guidance module 232. In general, the vehicle guidance module 232 may be configured to guide the work vehicle 202 along the various guidance lines generated by the path planning module 230 when performing the bale collection operation. In doing so, the manner in which the vehicle guidance module 232 is configured to “guide” the work vehicle 202 along the guidance lines may vary depending on the configuration and/or operating mode of the work vehicle 202. For example, when the work vehicle 202 corresponds to an autonomous vehicle and/or when the work vehicle 202 is configured to implement an autonomous driving mode in which the operation of the vehicle 202 is automatically controlled, the vehicle guidance module 232 may be configured to “guide” the work vehicle 202 along the guidance lines by electronically controlling the steering assembly 208 (and/or any other suitable vehicle components, such as the engine 204 and/or the transmission 204) to allow the vehicle 202 to be automatically moved along the appropriate guidance line(s) during the performance of the bale collection operation. Alternatively, when the work vehicle 202 is being manually operated by an operator, the vehicle guidance module 232 may be configured to cause a map to be displayed on the vehicle's display device 214 that illustrates the vehicle's location relative to the guidance line(s) to be traversed by the vehicle 202. In such an embodiment, the operator may use the map displayed on the display device 214 as a visual reference for steering the work vehicle 202 across the field when performing the bale collection operation.

As shown in FIG. 3, the controller 212 may also include a communications interface 234 to provide a means for the controller 1212 to communicate with any of the various other system components described herein. For instance, one or more communicative links or interfaces 236 (e.g., one or more data buses) may be provided between the communications interface 234 and one or more other components of the work vehicle 202 to allow data and/or control commands to be transmitted between the controller 212 and such component(s).

Additionally, it should be appreciated that, although the system controller 212 has generally been described herein as being provided in operative association with or otherwise forming part of the illustrated work vehicle 202, the controller 212 may, instead, correspond to a separate controller or computing device. For instance, in one embodiment, the controller 212 may correspond to a computing device separate from the work vehicle 202 that is configured to perform one or more of the various functions described herein, such as by determining the location and/or arrangement of the staging area and/or by generating the various guidance lines across which the work vehicle 202 is to be traversed when collecting the bales and subsequently delivering the bales to the staging area. In such an embodiment, the planning data or other data generated by the controller 212 when performing such functions may then be transmitted to a corresponding controller of the work vehicle 202 to allow the bale collection operation to be performed by the vehicle 202.

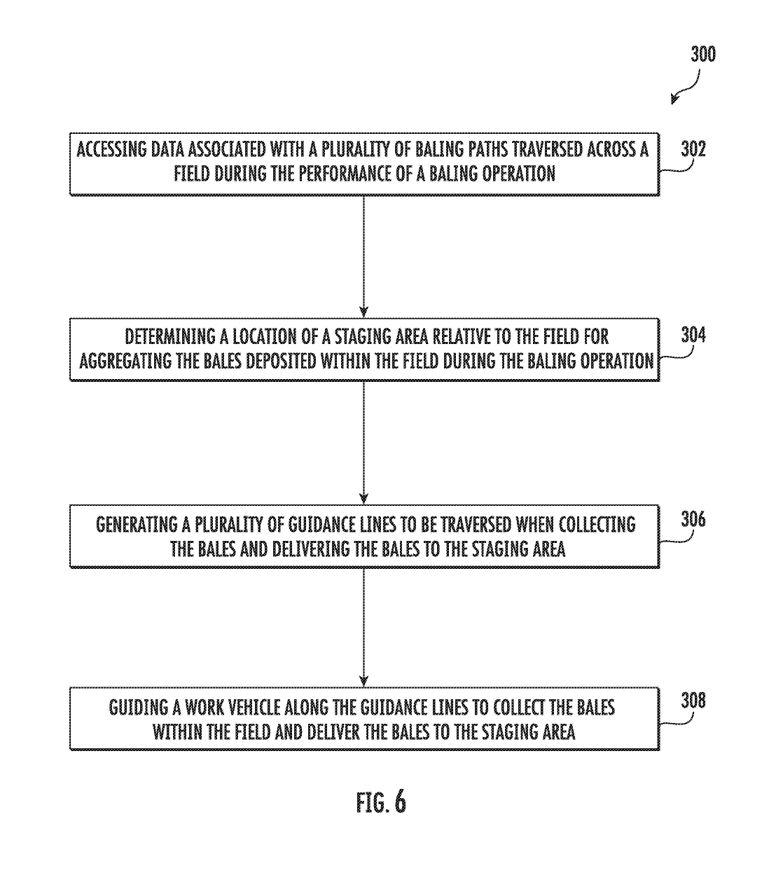

Referring now to FIG. 6, a flow diagram of one embodiment of a method 300 for performing a bale collection operation is illustrated in accordance with aspects of the present subject matter. In general, the method 300 will be described herein with reference to the system 200 described above with reference to FIG. 3, as well as the example baling operation and bale collection operation described above with reference to FIGS. 2, 4 and 5. However, it should be appreciated that the disclosed method 300 may be implemented with systems having any other suitable system configuration and/or in connection with the performance of any suitable baling operation and/or bale collection operation. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (302), the method 300 may include accessing data associated with a plurality of baling paths traversed across a field during the performance of a baling operation. For instance, as indicated above, data may be stored within the controller's memory 218 that is associated with the baling paths 102 previously traversed during a baling operation, such as position data associated with the specific location of each bale 106 deposited within the field 100, position data tracking the specific baling path(s) 102 traversed across the field 100 when performing the baling operation, and/or data associated with the vehicle heading for each baling path 102.

Additionally, at (304), the method 300 may include determining a location of a staging area relative to the field for aggregating the bales deposited within the field. For example, as indicated above, the controller 212 may, in one embodiment, be configured to automatically select a location for the staging area 120, such as by selecting a centralized location within the field 100 to serve as the staging area 120 (e.g., as determined based on the locations of the bales 106 and/or the size/shape of the field 100). Alternatively, the controller 212 may be configured to set the location of the staging area 120 based on inputs received from the operator and/or based on other pre-defined user preferences.

Moreover, at (306), the method 300 may include generating a plurality of guidance lines to be traversed when collecting the bales and delivering the plurality of bales to the staging area. For example, as indicated above, the controller 212 may be configured to generate suitable guidance lines that optimize the efficiency of performing the bale collection operation while taking into account considerations of field compaction and/or yield losses. Specifically, in several embodiments, the guidance lines generated by the controller 212 may include one or more bale collection guidance lines 130 defined relative to the baling paths 102 and one or more staging guidance lines 134 connecting the bale collection guidance lines 130 to the staging area 120. For example, as indicated above, each bale collection guidance line 130 may, in one embodiment, be defined between a corresponding pair of adjacent baling paths 102, with a common staging guidance line 134 connecting the various bale collection guidance lines 130 to the staging area 120.

Referring still to FIG. 6, at (308), the method 300 may include guiding a work vehicle along the guidance lines to collect the bales within the field and deliver the bales to the staging area. Specifically, as indicated above, the controller 212 may, in certain embodiments, be configured to automatically control the operation of the work vehicle 202 (e.g., for an autonomous vehicle or when the work vehicle is operating in an autonomous or auto-guidance mode). In such embodiments, the controller 212 may be configured to control the operation of suitable components of the work vehicle 202 (e.g., the engine 204, transmission 206, and/or the steering assembly 208) to guide the vehicle 202 along the guidance lines for performing the bale collection operation. Alternatively, the controller 212 may be configured to display the guidance lines on a suitable display device 214 of the vehicle 202 (e.g., via a map displayed on a user interface) to serve as a guide for the operator when operating the vehicle 202 to perform the bale collection operation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for performing a bale collection operation, the method comprising:
accessing, with a computing device, data associated with a plurality of baling paths traversed across a field during the performance of a baling operation, each baling path being associated with at least one bale of a plurality of bales to be collected within the field;
determining, with the computing device, a location of a staging area relative to the field for aggregating the plurality of bales;
generating, with the computing device, a plurality of guidance lines to be traversed when collecting the plurality of bales and delivering the plurality of bales to the staging area, the plurality of guidance lines including at least one bale collection guidance line defined relative to at least one of the baling paths and at least one staging guidance line extending between the at least one bale collection guidance line and the staging area; and
guiding, with the computing device, a work vehicle along the plurality of guidance lines to collect the plurality of bales within the field and deliver the plurality of bales to the staging area.

2. The method of claim 1, wherein accessing data associated with the plurality of baling paths comprises accessing data associated with at least one of a location of each of the plurality of bales within the field or a vehicle heading when each of the plurality of bales was deposited within the field during the baling operation.

3. The method of claim 1, wherein determining the location of the staging area comprises automatically determining the location of the staging area based on at least one of a location of each of the plurality of bales within the field or data associated with at least one of a size or shape of the field.

4. The method of claim 1, wherein determining the location of the staging area comprises determining a centralized location within the field to be used as the location of the staging area.

5. The method of claim 1, wherein determining the location of the staging area comprises receiving an operator input associated with a selection of the location of the staging area relative to the field.

6. The method of claim 1, wherein the at least one bale collection guidance line comprises a plurality of bale collection guidance lines, wherein generating the plurality of guidance lines comprises generating the plurality of bale collection guidance lines such that the plurality of bale collection guidance lines are offset from the plurality of baling paths.

7. The method of claim 6, wherein generating the plurality of bale collection guidance lines comprises generating the plurality of bale collection guidance lines such that each bale collection guide line is positioned between a corresponding pair of adjacent baling paths.

8. The method of claim 6, wherein the at least one staging guidance line comprises a common staging guidance line extending between the staging area and each of the plurality of bale collection guidance lines.

9. The method of claim 1, further comprising generating a staging grid for placement of the plurality of bales within the staging area.

10. The method of claim 9, wherein the staging grid is generated based, at least in part, on at least one of a number of the plurality of bales, a bale type of the plurality of bales, or a bale size of the plurality of bales.

11. The method of claim 9, further comprising determining a location for each of the plurality of bales within the staging grid based, at least in part, on a position of each bale relative to the staging grid.

12. The method of claim 1, wherein guiding the work vehicle along the plurality of guidance lines comprises automatically controlling an operation of the work vehicle such that the work vehicle is traversed along the plurality of guidance lines to collect the plurality of bales within the field and deliver the plurality of bales to the staging area.

13. The method of claim 1, wherein guiding the work vehicle along the plurality of guidance lines comprises displaying the plurality of guidance lines on a display device of the work vehicle to allow an operator of the work vehicle to navigate the work vehicle along the plurality of guidance lines to collect the plurality of bales within the field and deliver the plurality of bales to the staging.

14. A system for performing a bale collection operation, the system comprising:
a work vehicle configured to collect a plurality of bales located within a field;
a controller provided in operative association with the work vehicle, the controller including a processor and associated memory, the memory storing instructions that, when implemented by the processor, configure the controller to:
access data associated with a plurality of baling paths traversed across the field during the performance of a baling operation, each baling path being associated with at least one bale of the plurality of bales;
determine a location of a staging area relative to the field for aggregating the plurality of bales;
generate a plurality of guidance lines to be traversed by the work vehicle when collecting the plurality of bales and delivering the plurality of bales to the staging area, the plurality of guidance lines including at least one bale collection guidance line defined relative to at least one of the baling paths and at least one staging guidance line extending between the at least one bale collection guidance line and the staging area; and
guide the work vehicle along the plurality of guidance lines to collect the plurality of bales within the field and deliver the plurality of bales to the staging area.

15. The system of claim 14, wherein the data associated with the plurality of baling paths comprises at least one of data associated with a location of each of the plurality of bales within the field or a data associated with a vehicle heading when each of the plurality of bales was deposited within the field during the baling operation.

16. The system of claim 14, wherein the controller is configured to determine the location of the staging area based on at least one of a location of each of the plurality of bales within the field, data associated with at least one of a size or shape of the field, or an operator input associated with a selection of the location of the staging area relative to the field.

17. The system of claim 14, wherein the at least one bale collection guidance line comprises a plurality of bale collection guidance lines, wherein the controller is configured to generate the plurality of bale collection guidance lines such that each bale collection guide line is positioned between a corresponding pair of adjacent baling paths.

18. The system of claim 17, wherein the at least one staging guidance line comprises a common staging guidance line extending between the staging area and each of the plurality of bale collection guidance lines.

19. The system of claim 14, wherein the controller is further configured to generate a staging grid for placement of the plurality of bales within the staging area.

20. The system of claim 14, wherein the controller is configured to guide the work vehicle along the plurality of guidance lines by automatically controlling an operation of the work vehicle such that the work vehicle is traversed along the plurality of guidance lines or by displaying the plurality of guidance lines on a display device of the work vehicle to allow an operator of the work vehicle to navigate the work vehicle along the plurality of guidance lines.
